(19) United States
(12) Patent Application Publication
(10) Pub. No.: US 2010/0302054 A1
(43) Pub. Date: Dec. 2, 2010

(54) DISPLAY DEVICE FOR A DIVE COMPUTER

(76) Inventors: Lukas Metzler, Appenzell (CH); Markus Mock, Uster (CH); Ernst Voellm, Kilchberg (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/681,025

(22) PCT Filed: Sep. 30, 2008
(86) PCT No.: PCT/EP08/08296

§ 371 Date: Aug. 13, 2010

(30) Foreign Application Priority Data
Oct. 2, 2007 (DE) 10 2007 047 144.2

(51) Int. Cl. G08B 5/00; G06F 3/048; H05B 37/02

(52) U.S. Cl. 340/815.4; 715/772; 250/214 AL; 715/781

(57) ABSTRACT

Display device for displaying information during a dive on a dive computer. The dive computer comprises a screen, measuring devices that detect variables related to the dive, a memory device to store data and program steps, and a computing device that processes the measurements made by the measuring device and derives data therefrom. A plurality of masks are stored in the dive computer to arrange dive data on the screen. The computing device determines characteristics from the dive data to select the mask characterizing the dive situation.

The present invention relates to a display device for displaying information during a dive on a dive computer, with at least one screen, a plurality of measuring devices that detect variables related to the dive, a memory device to store data and program steps, and a computing device that processes the measurements made by the measuring device and derives data therefrom that are characteristic of a dive situation.

A display device for a dive computer of the kind just mentioned is disclosed by US 2003/0056786, which has differing fixed prescribed areas arranged on its screen to display dive data statically. In the central area of the screen there are 7-segment displays to show numerical information, for example the current dive depth or diving and ascending times. In the bottom left marginal area of the screen there is a segmented bar display for oxygen toxicity and above it a segmented bar display that symbolizes increasing oxygen saturation of the diver's tissue. A warning symbol is added in when the particular threshold is exceeded. In the right area of the screen there is another segmented bar display that symbolizes with an increasing number of added bars an increasing rate of ascent. In each of the three segmented bar displays, beside the screen, there are markings in the edge area of the case that help the diver recognize whether the added bar segments are approaching the threshold value. Between these displays there are also other symbols on the screen that can be added in depending on the dive situation. Because of the large amount of information, partially interlaced, there is a danger that a diver will recognize important information too late.

EP 1 371 548, for example, discloses how to display the current dive depth in the form of a graph that runs within an allowable dive range around a depth reference line. EP 1 020 352 also discloses how to lay out the screen in a warning color to inform the diver that a dive parameter has exceeded a threshold.

In other dive computers, the user can choose between various display variants for the screen. These show a differing number of messages constantly on the screen. Other information can be called up by switching the display. It is known here that the constantly indicated values can be configured by the diver. It is also known how to replace the value shown in the screen area with other dive data depending on the dive situation.

It is common to the known display devices that a large amount of dive data are shown largely statically in fixed areas of the screen. The diver is primarily advised to follow the relevant messages during the dive in order to recognize dangerous situations quickly and to be able to select and carry out suitable measures in each case.

The underlying purpose of this invention is to make available a display device for a dive computer that avoids the drawbacks of existing display devices and thus increases diver safety.

This task is accomplished according to the invention by the subject matter of claim 1. Beneficial refinements are the subject of the subclaims.

The solution of the task provides for a display device that serves to display information during a dive. The dive computer comprises at least one screen, a plurality of measuring devices that detect measured variables related to the dive, a memory device to store data and program steps, and a computing device that processes the measured variables detected by the measuring device and derives dive data therefrom, which are characteristic of a dive situation. A number of masks are stored in the memory device of the dive computer to arrange dive data on the at least one screen. The computing device determines characteristics from the dive data that are used to select the mask characterizing the dive situation.

A dive computer with a display device according to the invention comprises a number of measuring devices that detect measured variables related to the dive. In a simple embodiment, this number of measuring device can consist of just two measuring devices that measure the ambient pressure and the time, for example. Dive computers with broader functionality, however, also comprise measuring devices to detect the ambient temperature, the air supply, for example in a compressed air tank and/or the air consumption of the diver, as well as other measuring device. The measured variables are preferably stored in a memory device of the dive computer, which can also be made up of multiple memory units. Program steps for processing detected data and data already present in the dive computer are also kept in this memory device. A computing device of the dive computer, which likewise may consist of multiple computing units, reads the measured variables detected by the measuring devices and from them, using program steps stored in the dive computer, determines which dive data are characteristic of the dive situation in which they are detected.

The dive data are displayed on at least one screen of the dive computer. For better comprehensibility it is preferred to arrange the display of safety-relevant dive data on a single screen. Depending on the dive situation, the data are presented pursuant to the invention in different masks or mask areas that are selected in accordance with the template, so that the particular information needed currently is displayed for the diver. It is preferred for a number of masks for the arrangement of dive data on the screen to be stored in the memory device, so that a suitable mask is available for each situation that can be determined by the dive data. The masks are preferably structured so that they can also be assembled from multiple mask areas depending on the situation. The mask areas also preferably change their mutual positions depending on one or more detected measured values.

The computing device preferably derives characteristics from the dive data determined in the dive computer that are used to select and preferably also to position the mask suitable for the specific situation. The type and number of displayed dive data and symbols, as well as preferably their depiction and arrangement on the screen are established in a mask.

To prepare a number of different masks, the display device pursuant to the invention comprises a preferably graphic screen, preferably with color display capability. To make it possible for the diver in any situation quickly to recognize the displayed data, this screen is preferably illuminated. The lighting intensity is preferably adapted to the surroundings to guarantee easy legibility. In a preferred embodiment, this function is achieved by means of solar cells integrated into the dive computer that determine the ambient brightness. The determined value then is used to control the screen lighting. An inverse screen presentation is preferred if there is only a small amount of light remaining in the dive environment.

In this way the diver is helped to recognize important information quickly, for example before having to turn on the screen lighting before reading the data. Values that are not presented on the mask currently shown on the screen are preferably located clearly outside of a critical area and do not have to be observed by the diver. This avoids a diversion of the diver from the information relevant for the prevailing situation. The masks are also configured so that the dive data are large and easily readable. The language of the textual information displayed can preferably be set. In the case of English terms generally known in the diving sector, warnings are preferably displayed in the English language in parallel with a selected display language, to help further in recognizing critical situations.

The basic structure of a display pursuant to the invention will be described below. Information with little safety relevance but of which the diver would like always to be informed, such as person-related data, ambient temperature, or cumulative diving time, are preferably located in the marginal area of the normal display. Data that enter into the calculation of dive data but that the diver should likewise have in view for safety reasons, such as the gas mixture setting, the bottle pressure, or the functional display of the pressure sensor, are likewise preferably located in the marginal area.

Quickly assignable types of presentation of the same kind are preferably chosen in each case in the masks for warnings and alarms. These are preferably identical color configurations in a graphic screen, for example such as orange for warnings and red for alarms. The definition of an inversely colored mask is also beneficial so that the display is noticed quickly by the diver.

The screen preferably comprises two mask areas that are preferably displayed in each dive situation. The actual situation of the diver is presented in the first mask area, and a recommended target situation in a second area if there is a recommended action for the diver.

The current dive depth is preferably shown in the first mask area in each dive situation. The second dive information, which is preferably shown in this first area, is preferably the indication of the time remaining before the diver should start his return to the surface because the gas supply is coming to an end. A mobile layout element is preferably shown in this first mask area, the arrangement of which symbolizes the current dive depth.

In a second constantly shown mask area, the time remaining is shown in a first dive situation in which ascent can be carried out without a decompression stop. If a diver wants to ascend without a decompression stop, this should be done within this indicated time. This mask area preferably changes just before this time expires. The expiration of the remaining time without a decompression stop is preferably shown prominently in the masks preferably shown briefly. After this time runs out, a different second mask area is preferably selected based on the derived characteristics. The dive depth in which a decompression stop is necessary, as well as the information on the required time for decompression, are displayed in the mask now shown. A layout element that symbolizes the “target” depth, i.e. the depth of the next recommended decompression stop, is also located in this second area. A picture is given to the diver of his current depth relative to the decompression depth, from the arrangement of the layout elements of the first and second areas of the display relative to one another. It is advantageous in this case for the distance between the current dive depth and the depth of the next decompression stop to stand out for the diver based on this arrangement of the layout elements of the first and second mask areas, without first having to calculate the difference between the two displayed values. Errors are thus avoided based on the display pursuant to the invention.

To illustrate dive data approaching threshold values that are critical in themselves, such as the partial pressure of oxygen and the oxygen toxicity, the rate of ascent, or other dive data such as the expiration of the decompression-free time, are preferably shown in one or more other mask areas, and preferably in the form of a segmented bar display. Depending on the current situation in which a value is developing toward a critical threshold value, these mask areas are preferably located in one or more similar display areas of the screen.

For reasons of easy comprehension, all segmented bars in segmented bar displays are preferably overlaid reset graphically. The segmented bar corresponding to the current value is then preferably emphasized graphically. In a critical region of the displayed value, a mask is selected that comprises a danger symbol. If a danger situation results from the approach of the bar display to the threshold value, then a mask is preferably selected based on the characteristic data that comprises a recognizably different symbol for a recommended action instead of a previously shown ascending or descending arrow. The diver thus preferably recognizes just from a quick glance at the screen that he is approaching a dangerous situation and should take the indicated action.

If the threshold value is exceeded, after the value to be displayed rises above the value symbolized by the uppermost bar, a warning mask is preferably selected that preferably differs distinctly from the normal display. The diver is told by this mask, preferably in a warning color, to take action in accordance with the presented warning instructions to escape from a dangerous situation. Only the immediately necessary data are preferably displayed in this warning mask that the diver needs to overcome the dangerous situation. This is always preferably the current depth in a first mask area, and for example, the indication of the dive depth of a necessary decompression stop or the maximum dive depth in a second mask area. The layout elements and the positioning of the first and second mask areas from which the diver obtains his current dive depth compared to the necessary decompression stop, for example, help the diver to recognize the dangerous situation quickly, and to initiate the proper measures in this situation.

To switch back from the warning mask into a normal display mode, it is preferably necessary for the diver to confirm that he has noticed the warning. Based on the dive data, the selection is then made of a mask that indicates to the diver other dive data specific for the current situation, for example such as the maximum depth at which he can stay. A mask that contains a warning symbol corresponding to the previously indicated dangerous situation is also selected based on the prevailing characteristics. A mask selected in such a situation preferably comprises an action symbol, for example such as an arrow that indicates to the diver whether he should move to a greater dive depth, for example after ascending too quickly or after bypassing a compression stop. A mask is chosen that does not include the warning symbol or the action symbol based on the determined characteristics only after it results from the determined dive data that the critical situation has been overcome.

Manual confirmation of the warning notice preferably cannot be performed for certain hazardous situations. The warning mask preferably remains active until the diver again behaves in conformity with normal rules.

If a diver disregards a recommended decompression stop, for example, a dangerous situation arises for him. A mask with a warning display and preferably an action symbol like a downward-pointing arrow is then selected with reference to the determined characteristics. The layout element with the current dive depth in this situation is located above the layout element shown in the second mask area that symbolizes the dive depth of the necessary decompression stop. From this and from the action symbol, the diver quickly understands what step he should take to overcome the dangerous situation.

A preferred embodiment of the display device for a dive computer is designed so that it is signal-linked to a second screen. This second screen is preferably located in a diver's mask and is designed so that the diver can readily discern the information shown on it. The signal linkage to the second screen is preferably wireless, for example by means of long wave or ultrasound. Multiple variants can be considered for the scope of information transmitted to this second screen and provided for display. In a preferred first variant, the same data are sent to this second screen as to the screen of the dive computer. This then provides for the same display on both screens.

In a second preferred variant, data are sent to this second screen that are present in the dive computer but are not displayed, or only partially displayed, on the first screen. In a third especially preferred variant, only a selection of the information displayed on the dive computer is sent to the second screen in the diver's mask, for example warning notices, dive depth, or dive time information.

Other benefits, features, and possible uses of the present invention are found in the following description in combination with the Figures. The Figures show:

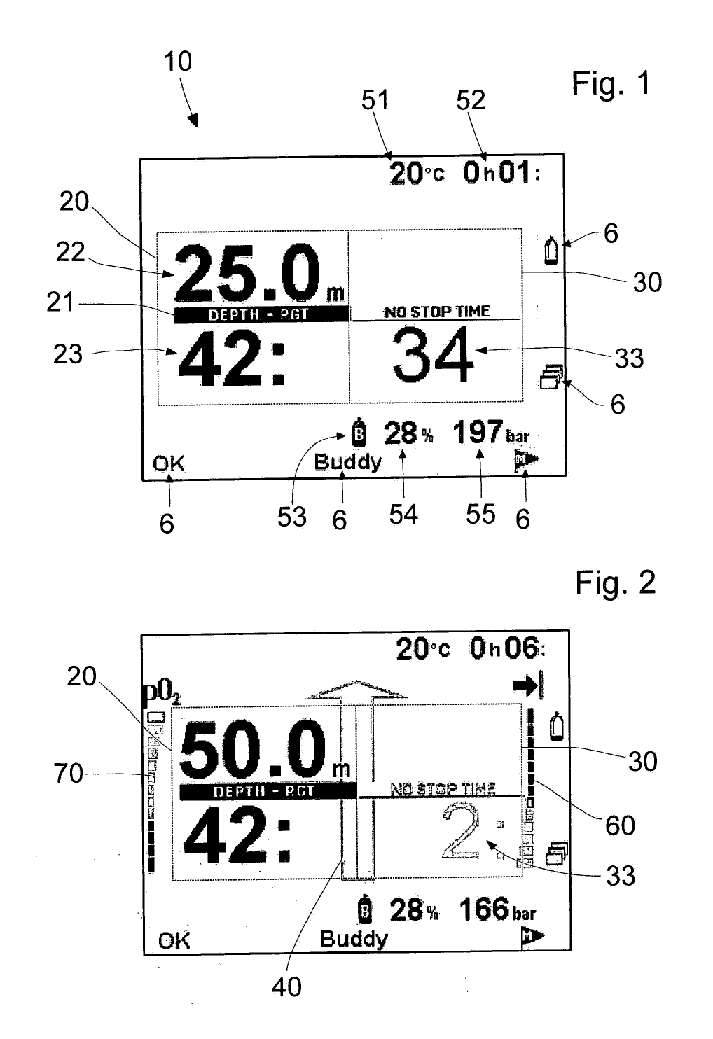

FIG. 1 a screen of an example of embodiment of the display device pursuant to the invention in a first dive situation,

FIG. 2 the screen of an example of embodiment in a second dive situation,

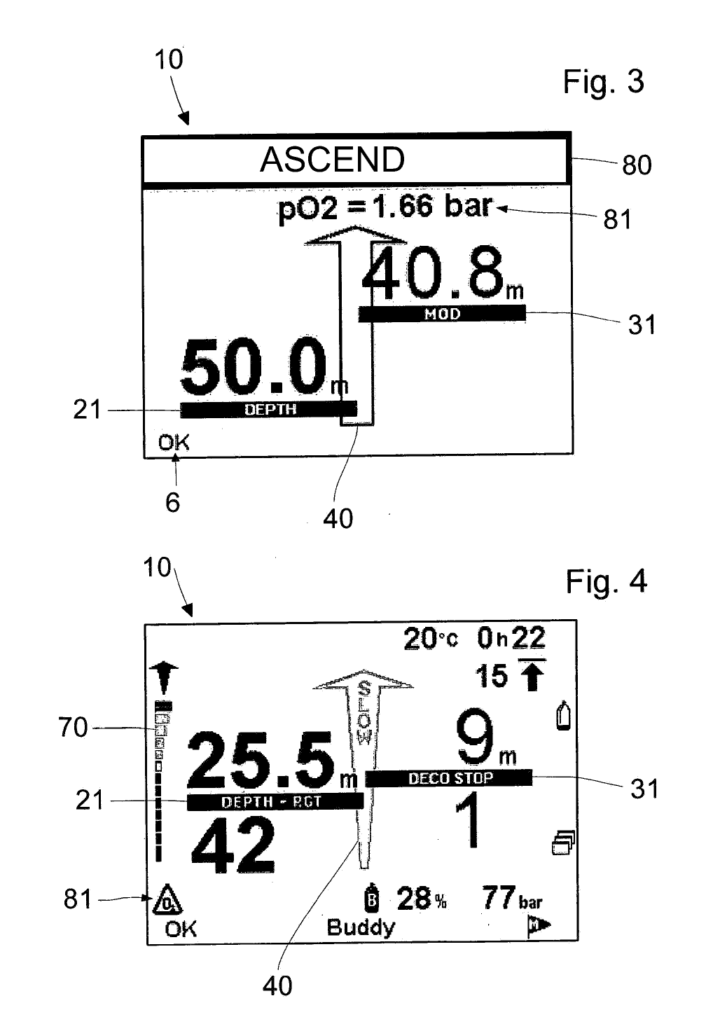

FIG. 3 the screen of an example of embodiment in a dangerous situation,

FIG. 4 the screen of an example of embodiment during an ascending phase,

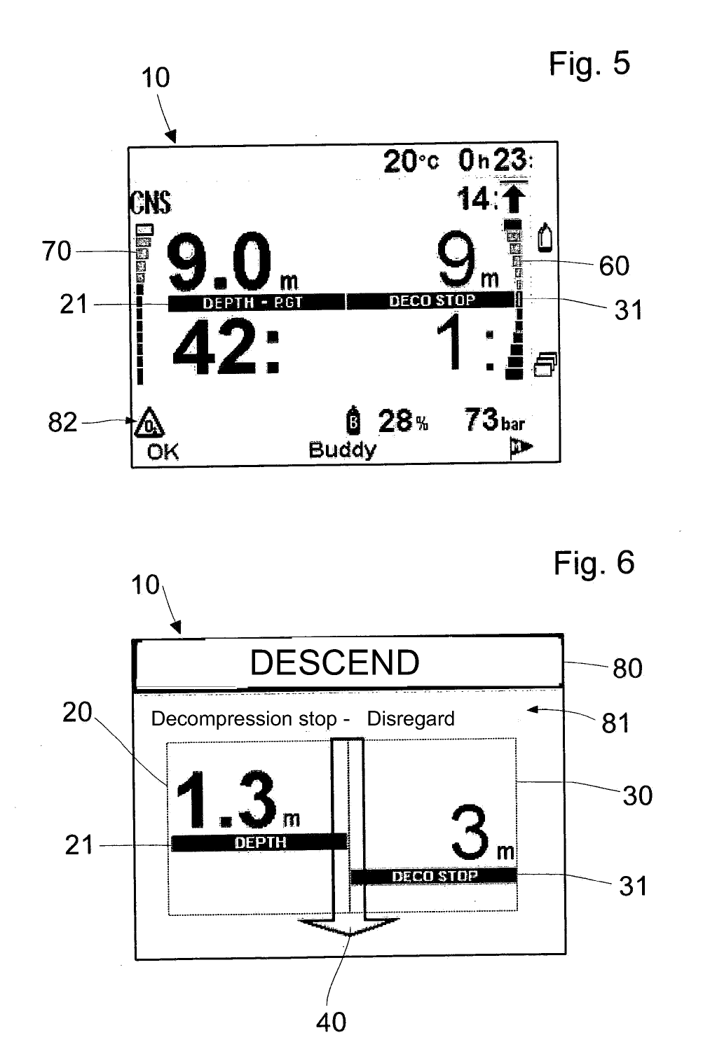

FIG. 5 the screen of an example of embodiment during a decompression stop, and

FIG. 6 the screen of an example of embodiment in a dangerous situation from missing a decompression stop.

FIG. 1 shows a screen 10 of an example of embodiment of the display device pursuant to the invention in a first dive situation. The diver can return to the surface at the time shown without a decompression stop. In a first mask area 20 that is shown on the left of the screen there is a layout element 21 that symbolizes in its vertical position the current dive depth 22 that is displayed above the layout element 21. The diving time remaining 23 with the air supply is displayed beneath the layout element 21. To assist in assigning the displayed values to the layout element 21, it is also inscribed to correspond. A layout element is only indicated in a second mask area 30 in this first dive situation. The time duration 33 that remains without a decompression stop being necessary when ascending is displayed in this second area 30.

Constantly displayed at the margin of the screen 10 is dive information such as the ambient temperature 51, the dive time 52 that has already transpired, a symbol 53 for the existing signal link between the bottle pressure sensor of the dive bottle currently being used and the dive computer, the mixture composition 54, and the pressure 55 in the compressed air bottle of the diver. Various symbols 6 are added in at the margin of the screen, for example, to help the diver when operating the control elements attached to the dive computer. With this, the diver obtains all of the information relevant for him in this first dive situation.

FIG. 2 shows the screen 10 in a second dive situation at the time when the diver has only two minutes left in which he can ascend without a decompression stop. This situation is recognizable for the diver at first glance from the emphasized layout of the second mask area 30. A mask is selected in this situation, based on the characteristics determined in the dive computer, that comprises an action symbol 40, in this case an ascending arrow. The diver obtains the instruction to ascend from the mask displayed in this situation, if he wants to keep to the zero time. A segmented bar display 60 that shows graphically the expiration of the zero time is presented in the right area of the mask displayed on the screen 10. A segmented bar display 70 is shown in the left area of the mask displayed on the screen 10 that symbolizes an increasing oxygen partial pressure in the respiration air of the diver. In FIG. 2, the oxygen partial pressure determined already reaches a level that is just about to exceed the threshold value.

FIG. 3 shows the mask selected on the basis of the characteristics in the dangerous situation after exceeding the threshold value. The warning notice and the action to be taken are shown in the top area 80 and fill the screen in inverse format. The information 81 below it indicates to the diver why this action is urgently recommended. The action symbol 40 also shows the diver in this situation the action to be taken, ascent. The layout element 21 in the bottom area of the screen, because it is in the lowest area of the screen, shows that the current dive depth is below the target depth shown symbolically in the second area, which is indicated by the position of the layout element 31. The layout element 31 here symbolizes the maximum possible depth (Maximum Operating Depth) at which the diver should ascend immediately. By actuating the “OK” key that is located outside of the screen 10 next to the displayed symbol “OK” 6, the diver can again quit the warning mask.

FIG. 4 shows the screen 10 of an example of embodiment during a phase in which the diver is ascending. The rate of ascent is shown symbolically in the left area of the screen by a segmented bar display 70. The action symbol 40, which is shown in the central area of the screen 10, indicates to the diver that he is to ascend more slowly. This recommendation is also emphasized by the text “slow” in the action symbol 40, which represents a danger symbol in this situation. A warning symbol 81 for the continued risk of an elevated partial pressure of oxygen is also displayed in this situation in the bottom left area of the screen 10. Since the oxygen partial pressure in the prevailing situation is not in the vicinity of the threshold value, the associated segmented bar display is not included in the present mask. The diver deduces the distance to the next stop of his ascent from the vertical gap between the layout elements 21 and 31. The layout element 31 here stands for the target depth of the next decompression stop necessary during the ascent. The action symbol 40 also shows the diver that the ascent should be less rapid. The diver can read from the segmented bar display 70 on the left of the screen 10 what speed range he is in currently. The diver is thus led through the danger situation with reference to the displayed values and symbols, and is cared for in his safe return to the surface.

There is no “OK” key here for quitting the warning mask. The warning mask disappears only when the rate of ascent is within the tolerable range.

FIG. 5 shows the screen of an example of embodiment of the display device 10 during a decompression stop. The layout elements 21 and 31 are shown at the same height during a correctly executed decompression stop. There is a segmented bar display 60 in the right area of the screen 10, that shows the diver that he is at the target depth. Descent to a greater depth would be possible with no danger, as seen from the configuration of the segmented bar display, while ascent to a smaller depth is first associated with a warning situation and later with a dangerous situation. The segmented bars above the layout element 31 are therefore shown in a warning color or danger color. A segmented bar display 70 that symbolizes an oxygen toxicity just below the critical threshold value is overlaid in the left area of the screen 10.

FIG. 6 shows the screen 10 in a dangerous situation reached by disregarding a decompression stop. As in any mask, the current dive depth is displayed for the diver in the first mask area 20, and the target dive depth is shown in the second mask area 30. The diver recognizes from the arrangement of the two layout elements 21 and 31 that he is located at too small a depth. The action symbol 40, a descent arrow, shows the diver the necessary step, descent to a greater dive depth. At the top of the screen 10 there is also the warning 80 and the explanation for the occurrence of the warning situation, that a necessary decompression stop has been skipped.

1. Display device especially to display information during a dive, comprising:
at least one screen,
a plurality of measuring devices that detect variables related to the dive,
a memory device to store data and program steps,
a computing device that processes the measurements made by the measuring device and derives data therefrom that are characteristic of a dive situation,
characterized in that
a plurality of masks for arranging dive data on the at least one screen are stored in the memory device, and that
the computing device determines variables from the dive data that are used to select the mask characterizing the dive situation.

2. Display device pursuant to claim 1, characterized in that variables determined from the dive data are used to position the mask characterizing the dive situation.

3. Display device pursuant to claim 1, characterized in that a mask comprises multiple mask areas.

4. Display device pursuant to claim 1, characterized in that the type and number of dive data and symbols as well as their presentation and arrangement on the screen are established.

5. Display device pursuant to claim 1, characterized in that it the display device comprises a graphic screen with color display capability.

6. Display device pursuant to claim 1, characterized in that the screen is constantly illuminated, with the lighting intensity being adapted to the brightness of the surroundings.

7. Display device pursuant to claim 6, characterized in that solar cells placed on the dive computer determine at least one value for the ambient brightness that is used to control the display lighting.

8. Display device pursuant to claim 1, characterized in that information with little safety relevance and/or information that participates in calculating the dive data are located in the marginal area of the screen.

9. Display device pursuant to claim 1, characterized in that the screen comprises two mask areas that are displayed in every dive situation.

10. Display device pursuant to claim 9, characterized in that information relative to the actual situation is displayed in a first mask area.

11. Display device pursuant to claim 9, characterized in that information relative to the target situation is displayed in a second mask area depending on the dive situation.

12. Display device pursuant to claim 9, characterized in that a layout element is shown in the first mask area whose arrangement on the screen symbolizes the current dive depth.

13. Display device pursuant to claim 9, characterized in that a layout element is shown in the second mask area whose arrangement on the screen symbolizes a target dive depth.

14. Display device pursuant to claim 9, characterized in that a recommended diving motion for the diver is apparent from the arrangement of layout elements in the first and second mask areas.

15. Display device pursuant to claim 9, characterized in that after the zero time has expired in the second mask area, the dive depth and duration of a recommended first decompression stop are displayed.

16. Display device pursuant to claim 1, characterized in that segmented bar displays are used to show dive data that are approaching critical threshold values.

17. Display device pursuant to claim 16, characterized in that segmented bar displays are displayed in one or more equivalent display areas of the screen.

18. Display device pursuant to claim 16, characterized in that all segmented bars are always overlaid graphically reset for segmented bar displays.

19. Display device pursuant to claim 16, characterized in that the segmented bar corresponding to the current value is graphically emphasized.

20. Display device pursuant to claim 1, characterized in that in critical situations a mask is selected that includes a danger symbol.

21. Display device pursuant to claim 20, characterized in that the danger symbol is a symbol for a recommended action.

22. Display device pursuant to claim 1, characterized in that a warning mask is displayed when a threshold value is exceeded.

23. Display device pursuant to claim 22, characterized in that the warning mask displays a recommended action to the diver in a warning color and/or in a warning configuration.

24. Display device pursuant to claim 22, characterized in that only the immediately necessary data are displayed in the warning mask.

25. Display device pursuant to claim 22, characterized in that the diver confirms that a warning instruction has been noted in order to switch from the warning mask back to a normal display mode.

26. Display device pursuant to claim 25, characterized in that after confirmation of a warning instruction, a mask is selected that contains a warning symbol corresponding to a previously displayed dangerous situation.

27. Display device pursuant to claim 22, characterized in that it is possible to switch from a warning mask to a normal display mode only when the reason for selecting the warning mask has been corrected.

28. Display device pursuant to claim 1, characterized in that the display device is signal-linked to a second screen.

29. Display device pursuant to claim 28, characterized in that the second screen is located in a diver's mask.

30. Display device pursuant to claim 28, characterized in that the signal connection to the second screen is wireless.

31. Display device pursuant to claim 28, characterized in that the second screen is located on the dive computer.

32. Display device pursuant to claim 2, characterized in that:
a mask comprises multiple mask areas;
the type and number of dive data and symbols as well as their presentation and arrangement on the screen are established;
the display device comprises a graphic screen with color display capability;
the screen is constantly illuminated, with the lighting intensity being adapted to the brightness of the surroundings;
solar cells placed on the dive computer determine at least one value for the ambient brightness that is used to control the display lighting;
information with little safety relevance and/or information that participates in calculating the dive data are located in the marginal area of the screen; the screen comprises two mask areas that are displayed in every dive situation;
information relative to the actual situation is displayed in a first mask area;
information relative to the target situation is displayed in a second mask area depending on the dive situation;
a layout element is shown in the first mask area whose arrangement on the screen symbolizes the current dive depth;
that a layout element is shown in the second mask area whose arrangement on the screen symbolizes a target dive depth;
a recommended diving motion for the diver is apparent from the arrangement of layout elements in the first and second mask areas;
after the zero time has expired in the second mask area, the dive depth and duration of a recommended first decompression stop are displayed;
segmented bar displays are used to show dive data that are approaching critical threshold values;
segmented bar displays are displayed in one or more equivalent display areas of the screen;
all segmented bars are always overlaid graphically reset for segmented bar displays;
the segmented bar corresponding to the current value is graphically emphasized;
in critical situations a mask is selected that includes a danger symbol;
the danger symbol is a symbol for a recommended action;
a warning mask is displayed when a threshold value is exceeded;
the warning mask displays a recommended action to the diver in a warning color and/or in a warning configuration;
only the immediately necessary data are displayed in the warning mask;
the display device is signal-linked to a second screen; and
the signal connection to the second screen is wireless.

33. Display device pursuant to claim 32, characterized in that:
the diver confirms that a warning instruction has been noted in order to switch from the warning mask back to a normal display mode; and
after confirmation of a warning instruction, a mask is selected that contains a warning symbol corresponding to a previously displayed dangerous situation.

34. Display device pursuant to claim 32, characterized in that it is possible to switch from a warning mask to a normal display mode only when the reason for selecting the warning mask has been corrected.

35. Display device pursuant to claim 32, characterized in that the second screen is located in a diver's mask.

36. Display device pursuant to claim 32, characterized in that the second screen is located on the dive computer.
